(19) United States
(12) Patent Application Publication
(10) Pub. No.: US 2020/0276591 A1
(43) Pub. Date: Sep. 3, 2020

(54) PRESSURE PLATE APPARATUS

(71) Applicant: McCloskey International Limited, Keene (CA)

(72) Inventors: Dennis Duellman, Cudahy, WI (US); Marian Ando, Cudahy, WI (US); Andrzej Krol, Keene (CA)

(73) Assignee: McCloskey International Limited, Keene (CA)

(21) Appl. No.: 16/773,161

(22) Filed: Jan. 27, 2020

Related U.S. Application Data
(63) Continuation-in-part of application No. 16/288,403, filed on Feb. 28, 2019.

(51) Int. Cl. B02C 2/04

(52) U.S. Cl. CPC B02C 2/04

(57) ABSTRACT

A system for maintaining a downward force on a central shaft of a cone crusher having a stationary frame is provided, wherein the central shaft is mounted to rotate with respect to the stationary frame. The system may include a disc fixed to the frame and having a substantially centrally-disposed opening. A pressure plate may be mounted to and biased toward the central shaft and positioned below the disc. The pressure plate may have a surface that faces the disc and extends downwardly. The bias of the pressure plate toward the central shaft may bias the pressure plate against the disc during at least some crushing operations. The disc may exert a downward force on the pressure plate and on the central shaft to which the pressure plate is mounted during the at least some operations.

This application is a continuation-in-part of application Ser. No. 16/288,403, filed Feb. 28, 2019 and entitled Pressure Plate Apparatus.

### TECHNICAL FIELD

Embodiments disclosed herein relate generally to cone crushers and more specifically to a system for preventing the tendency of a cone crusher head to elevated and/or to rotate.

### BACKGROUND

Cone crushers are typically used to crush large rocks into smaller rocks at quarries. They include a conical crushing head that gyrates with a central shaft, the gyration of which is caused by a rotating eccentric surrounding the shaft. A hardened mantle covers the crushing head to crush rocks between it and a hardened liner of the crusher bowl in a crushing zone. The eccentric is driven by a diesel engine or electric motor power drive.

A cone head ball surface is typically mounted to the central shaft. This ball surface carries downward thrust loads, which it passes on to a stationary socket and thrust bearings disposed below the ball surface and socket interface. The thrust forces push the ball surface down on the stationary socket, creating friction that normally holds the shaft from rotating with the rotation of the eccentric. The downward thrust forces are anything but constant as the mantle gyrates and rocks enter and exit the crushing chamber. Without constant and substantial friction between the ball, which is mounted to the central shaft, and the stationary socket, the shaft and the mantle mounted to it may tend to rotate, which may create problems with the operation of the crusher.

Another drawback with some existing cone crushers is that, under particularly cold conditions, some cone crushers will exhibit what is called “cone head lift.” This phenomenon sometimes occurs during warm up of the crusher in cold weather, when the lubricating oil is especially viscous. Under these conditions, high internal fluid pressure may exceed the weight of the shaft and head, causing the head to lift. This can result in oil leakage and oil contamination, as well as damage to the oil seals. This cone head lift can be addressed by keeping a relatively constant downward pressure on the shaft, preventing the lifting even when forces generated by the thickened oil exceed the weight of the shaft and head.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 is a side elevation sectional view of a cone crusher incorporating a first embodiment of the pressure plate apparatus;

FIG. 2A is an enlarged, fragmentary, sectioned perspective view of the first embodiment of the pressure plate apparatus;

FIG. 2B is an enlarged, fragmentary, side elevation sectional view of the first embodiment of the pressure plate apparatus;

FIG. 2C is an enlarged, fragmentary, sectioned perspective view of the first embodiment of the pressure plate apparatus, with the surrounding structure of the crusher deleted for illustrative purposes;

FIG. 3 is a perspective view of an upwardly-facing side of the pressure plate of the first embodiment;

FIG. 4 is a side elevation sectional view of the pressure plate of the first embodiment;

FIG. 5 is a perspective view of an end cap of the first embodiment, looking from an upper angle;

FIG. 6 is a side elevation, partially sectioned view of the end cap of the first embodiment, showing a nut and cotter pin threaded to a lower end of the end cap;

FIG. 7 is a perspective view of a thrust washer disc of the first embodiment, looking from an upper angle

FIG. 8 is a perspective, sectioned view of a thrust washer disc of the first embodiment;

FIG. 9 is a side elevation sectional view of the first embodiment of the thrust washer disc depicted in FIGS. 7 and 8;

FIG. 10 is a perspective, sectioned view of a Belleville washer that may be used with the first embodiment;

FIG. 11 is a perspective, sectioned view of a housing that may be incorporated into the first embodiment, showing, among other things, an annular gap in which the Belleville washer(s) may be positioned;

FIG. 12 is a perspective view of the underside of the housing of FIG. 11;

FIG. 13 is a side elevation sectional view showing the interaction of the pressure plate with the thrust washer disc of the first embodiment; and

FIG. 14 is a fragmentary side elevation sectional view of a second embodiment of the pressure plate system;

FIG. 15 is a perspective view of the end cap of the second embodiment; and

FIG. 16 is a fragmentary side elevation sectional view of a third embodiment showing a pressure plate wear insert abutting the thrust washer disc.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense.

Various operations may be described as multiple discrete operations in turn, in a manner that may be helpful in understanding embodiments; however, the order of description should not be construed to imply that these operations are order-dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

One aspect of the present disclosure provides a system for maintaining a downward force on a central shaft of a cone crusher having a stationary frame, wherein the central shaft is mounted to gyrate with respect to the stationary frame. The system may include a disc fixed to the frame and having a substantially centrally-disposed opening, and a pressure plate mounted to and biased toward the central shaft and positioned below the disc, the pressure plate having a surface that faces the disc and extends downwardly, the bias of the pressure plate toward the central shaft biasing the pressure plate against the disc during at least some crushing operations, the disc exerting a downward force on the pressure plate and on the central shaft to which the pressure plate is mounted during the at least some operations.

When it is stated here and elsewhere in this disclosure that a surface of the pressure plate extends downwardly, this is to encompass even a slight downward extension, or a convex curvature in the surface (convex with respect to the upper portion of the crusher, or concave with respect to the bottom of the crusher). The phrase does not require that the entire pressure plate be shaped to extend downwardly—only the upper surface, although the phrase is to encompass a pressure plate configuration in which the entire plate is shaped to extend downwardly.

In this system, the bias may be imparted by at least one spring disposed between the pressure plate and the central shaft, and the at least one spring may be a stack of Belleville springs. The disc may also include a downwardly-facing surface that extends downwardly and faces the pressure plate. The meaning of the downwardly-facing surface of the disc extending downwardly is similar to the meaning of the phrase used in connection with the pressure plate.

The surface of the pressure plate facing the disc may be generally convex, and the configuration of the facing surfaces of the disc and pressure plate may complement each other. This does not mean, here or elsewhere in this disclosure, that the facing surfaces need to be identical or virtually identical but they should be similar enough that the pressure plate can slide around the disc during the gyration of the central shaft without interference that might cause overheating or damage to the pressure plate or the disc. However, in one aspect of the disclosure the shape of the downwardly-facing surface of the disc and the shape of the upwardly-facing surface of the pressure plate are the same; meaning that the contacting surfaces of the disc and the pressure plate are the same (although inverse because they face each other).

The system may include a housing mounted to the central shaft and an end cap mounted to the pressure plate, with the at least one spring disposed between the housing and the end cap, which may be slidably mounted to each other.

The end cap and the central shaft may be slidably mounted to each other, and end cap may extend upwardly into the central shaft.

The pressure plate may include a replaceable wear insert facing the disc that may be replaced when it is desired to change the configuration of the pressure plate or when the wear insert becomes worn.

Another aspect of the disclosure is a pressure plate apparatus for mounting to a gyrating central shaft in a cone crusher having a stationary frame, the pressure plate apparatus including a pressure plate that provides a downward force on the central shaft during at least some crushing operations. The apparatus may include a housing mounted to an underside of the central shaft, and an end cap mounted to the pressure plate and slidably mounted to the housing. At least one spring may be positioned between the housing and the end cap to bias the pressure plate toward the central shaft. A disc may be fixed to the stationary frame and disposed above the pressure plate, the disc having a centrally-disposed opening. The pressure plate may gyrate with the central shaft, with the disc exerting a downward force on the at least one spring, the pressure plate and the central shaft. In this aspect of the disclosure, the pressure plate and the disc extend downwardly in generally convex configurations.

Another aspect of the disclosure is a process for maintaining downward pressure on the cone of a cone crusher having a stationary frame, a central shaft, and an eccentric that gyrates the central shaft with respect to the frame. The process may include the following steps, not necessarily in the order recited: selecting a pressure plate having a downwardly-extending upwardly-facing surface; positioning at least one spring between the central shaft and the pressure plate; fixing a disc to the frame, the disc having a downwardly-extending and downwardly-facing surface and a substantially centrally-disposed opening; mounting the pressure plate to the central shaft such that the upwardly-facing surface of the pressure plate faces the downwardly-facing surface of the disc, the at least one spring exerting an upward bias on the pressure plate toward the disc, with the disc exerting a downward force on the pressure plate and the central shaft during at least a portion of the time the crusher is performing crushing operations.

Another aspect of the disclosure provides a process for maintaining downward pressure on the cone of a cone crusher having a stationary frame, a central shaft, a first and a second thrust bearing surface mounted to the central shaft that absorb at least some downward thrust during crushing operations, and a rotating eccentric that gyrates the central shaft with respect to the frame. The process may include the following steps, not necessarily in the order recited: mounting a housing to the central shaft; positioning at least one spring adjacent the housing; slidably mounting an end cap to the housing such that the at least one spring is disposed between the housing and the end cap; fixing a disc to the frame, the disc having a substantially centrally-disposed opening, and a generally convex downwardly-facing surface; selecting a plate having a generally convex upwardly-facing surface; and mounting the plate to the end cap such that the disc is disposed between the plate and central shaft and the at least one spring biases the plate toward the disc so that when crushing operations are initiated, the disc and the plate will exert a downward force on the central shaft and the plate will gyrate with the central shaft and with respect to the disc. This process may also include causing any debris disposed between the pressure plate and the disc to move radially outwardly until it drops off the pressure plate.

Another aspect of the disclosure provides a system for maintaining a downward force on a central shaft of a cone crusher having a stationary frame. The system may include a disc fixed to the frame, the disc having a substantially centrally-disposed opening. It may also include a plate mounted to the central shaft, with at least one spring disposed to exert an upward bias on the plate with respect to the central shaft. The plate and the disc are positioned against each other during at least some of the operations of the crusher so that the disc presses downwardly on the plate to exert a downward bias on the central shaft. The plate may include a replaceable wear insert facing the disc that may be replaced when it is desired to change the configuration of the plate or when the wear insert becomes worn.

In this latest aspect, the system may include a housing fixed to the central shaft, with the at least one spring disposed within the housing. In that embodiment an end cap may be fixed to the plate and slidably mounted to the housing, with the at least one spring disposed to exert a bias between the housing and the end cap.

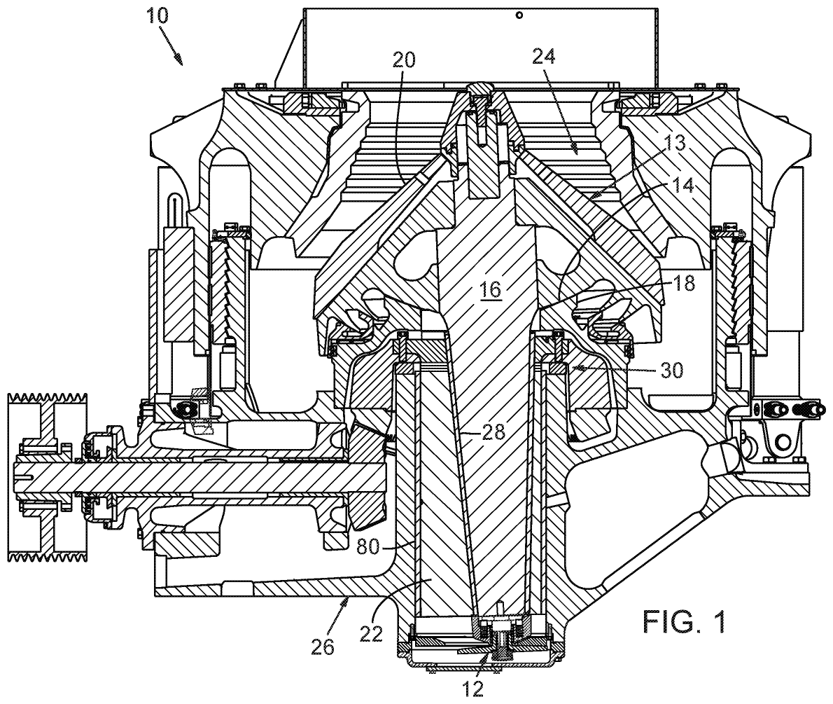

Reference should now be made to the figures, as this description continues. Crusher 10 is largely conventional, except for the pressure plate apparatus, generally indicated at 12, at the bottom of the crusher. FIG. 1 shows that cone crushers include a cone head 13 and a cone head ball surface 14, which is mounted to a central shaft 16. Ball surface 14 is disposed immediately above and rests against a stationary socket 18, which is mounted indirectly to the central shaft. A mantle 20 is mounted to the top of central shaft 16, which gyrates due to the action of a surrounding, rotating eccentric 22. The action of the gyrating mantle 20 moving toward a stationary bowl liner 22 breaks down rocks that enter a crushing zone 24 extending between the mantle and the liner. All of the foregoing components are mounted within a stationary crusher frame 26.

When rocks are fed into a crushing chamber 24, a crushing force acts on mantle 20, pushing the mantle downward and pressing central shaft 16 against a radial bearing 28. But most of the downward force is transmitted from central shaft 16 to ball surface 14 and stationary socket 18 and to a pair of flat, ring-type thrust bearings 30. As described above, this downward thrust of central shaft ball surface against stationary socket 18 creates friction between the ball surface and the socket, tending to prevent central shaft 16 and mantle 20 mounted to it from rotating. However, given the substantial and widely varying thrust forces generating during crushing operations, this force and therefore the amount of friction will vary greatly, providing for the possibility that cone head ball surface 14, central shaft 16 and mantle 20 may from time to time, rotate.

To counter this possibility and to provide a relatively constant amount of pressure between cone head ball surface 14 and stationary socket 18, pressure plate apparatus 12 is provided. This relatively constant pressure is effected by providing a constant downward force on central shaft 16 using at least one spring, the operation of which will be explained as this description continues.

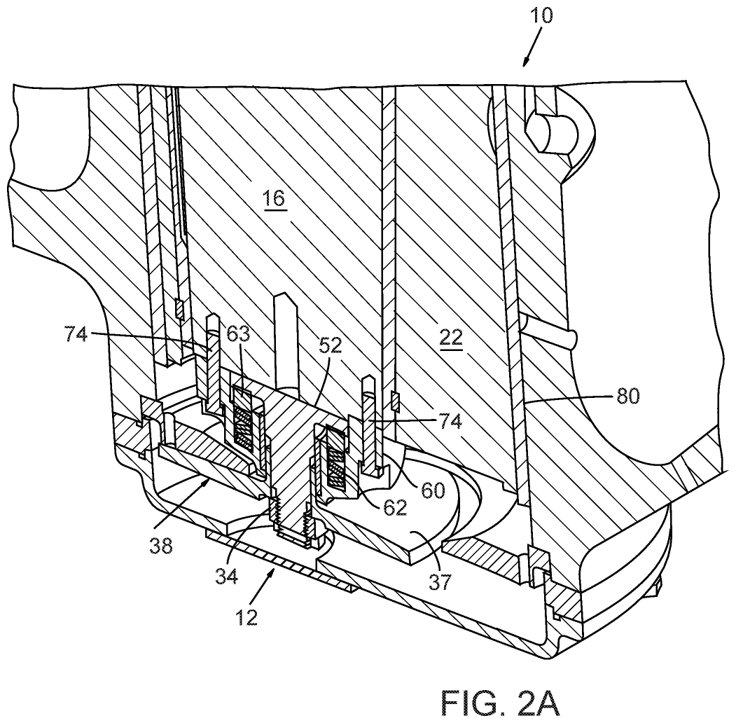

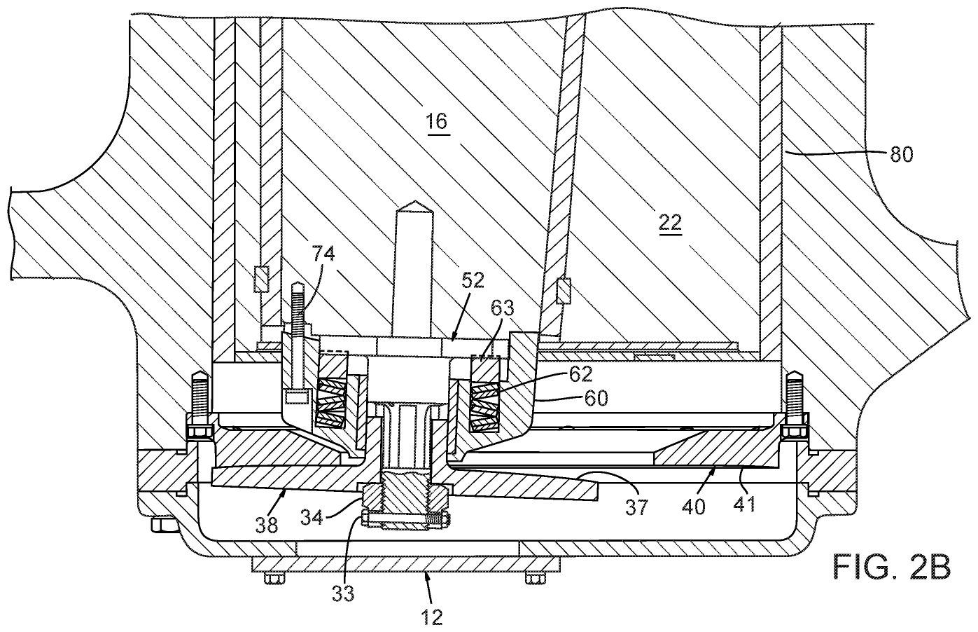

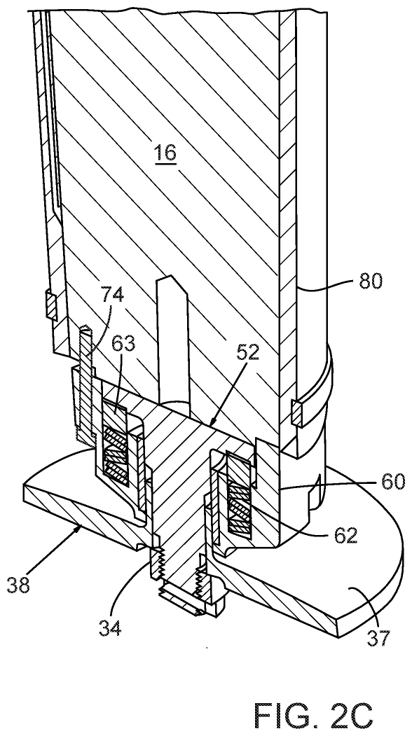

FIG. 1 shows a typical position of a pressure plate 38 in pressure plate apparatus 12. As shown best in FIGS. 2A-C and 6, pressure plate 38 is fastened to an end cap 52 by a nut 34, which is threaded on to threads 32 at the bottom of the end cap. A cotter pin or bolt 33 ensures that nut 34 is retained in position on end cap 52.

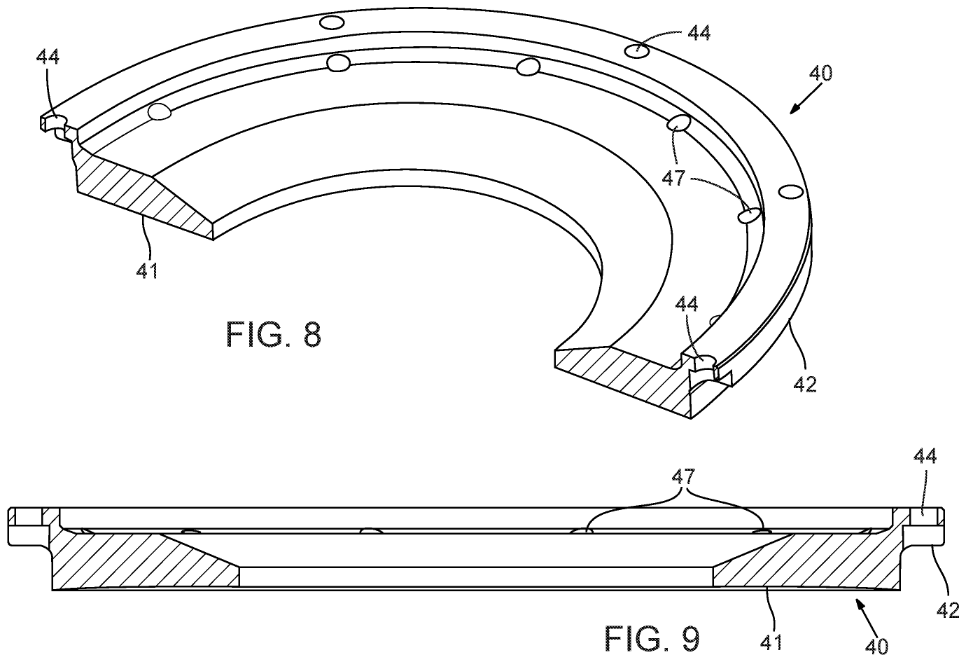

Pressure plate 38, may be generally circular in configuration. Thrust washer disc 40 is also generally circular in configuration as shown best in FIGS. 2A-B and 7-9, and includes a substantially centrally-disposed opening 43 that may be generally circular in shape and may be said to have a first diameter. Pressure plate 38 may be said to have a second diameter, which may be larger than the first diameter of the thrust washer disc central opening 43. The outer periphery of thrust washer disc 40 includes a flange 42 that is bolted via bolt holes 44 to frame 26. However, it should be understood that the substantially centrally-disposed opening of the disc may not be generally circular and it is not necessary that the second diameter of the pressure plate be larger than the first diameter of the disc opening. As shown in FIGS. 7-9, thrust washer disc 40 also typically includes lubrication openings 47 to facilitate lubrication between disc 40 and pressure plate 38. An appropriate pattern of channels (not shown) may be provided in in the downwardly-facing surface 41 of disc 40 and/or in the upwardly-facing surface 37 of pressure plate 38 to spread lubrication over the interface between the disc and the pressure plate.

FIGS. 1, 2A-B and 13 show pressure plate 38 at one side of thrust washer disc 40. Given that central shaft 16 is always off to one side of center, these figures illustrate a typical relative disposition of pressure plate 38 and thrust washer disc 40.

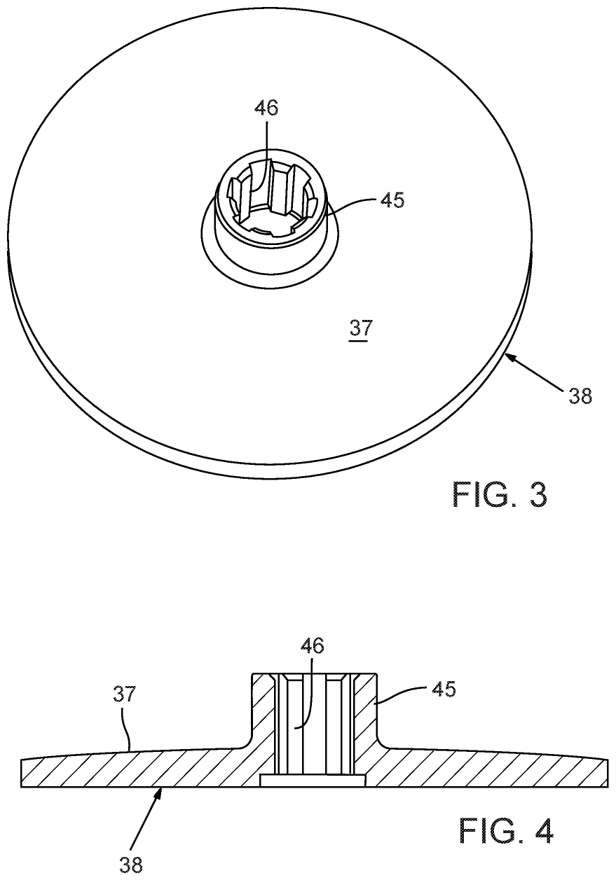

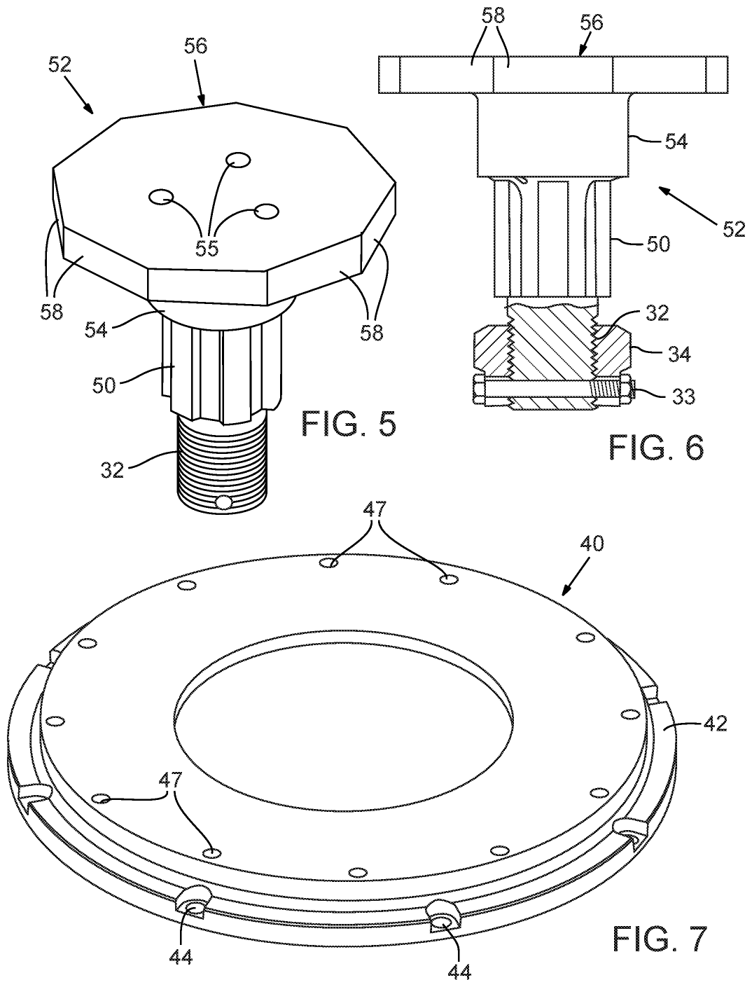

FIGS. 3 and 4 illustrate that pressure plate 38 includes a raised portion 45 with an internally splined region 46. A complementing splined region 50 in end cap 52, is shown best in FIGS. 5 and 6. End cap 52 also includes a raised annular shoulder 54 and a broad platform 56. Platform 56 may be multi-sided, with sides 58, as shown best in FIG. 5. Lubrication holes 55 may be positioned in platform 56 to facilitate lubrication of the interface between shoulder 54 and the adjacent bearing, to be described below.

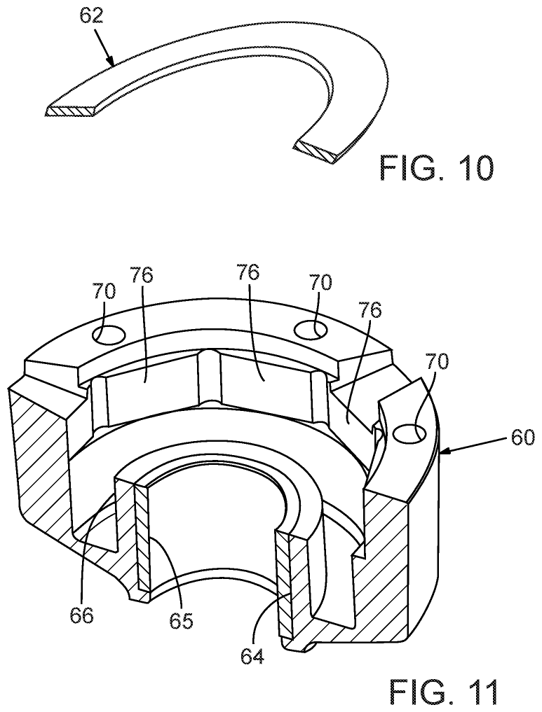

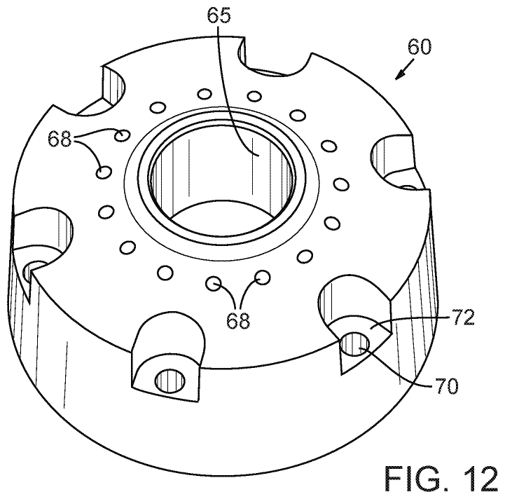

A housing 60, shown best in FIGS. 11 and 12, may also be included, with at least one spring being disposed between the housing and the end cap. It is possible that a plurality of springs may be disposed in aligned holes spaced around the housing but in the depicted embodiment a plurality of slightly conically-shaped so-called Belleville washers or springs 62 are positioned in the housing. With a plurality of Belleville springs 62 included, the springs form a stack. As shown in FIGS. 2A-C, in the preferred embodiment, springs 62 include pairs of springs mounted in alternating dispositions to provide the appropriate amount of bias. A circular spacer 63 may be disposed above the Belleville springs 62 and below platform 56 of end cap 52.

The housing shown in FIGS. 11 and 12 may be generally cylindrical but with many features designed to retain various components and fit within and between other components of pressure plate apparatus 12. For example, housing 60 includes a cylindrical passage 64 designed to receive the raised portion 45 of pressure plate 38 as well as the central extension 50 of end cap 52. A bushing or bearing 65 may be provided in the inner periphery of cylindrical passage 64. The housing also includes an annular gap 66 designed to receive and retain Belleville springs 62. Annular gap 66 does not extend entirely through housing 60 so that the springs bottom out in the housing. One or more venting openings 68 may be provided in annular gap 66.

Also included in housing 60 are a plurality of bolt holes 70 evenly positioned around the periphery of the housing, provided with shoulders 72 to support the heads of bolts 74 that extend therethrough. As seen in FIGS. 2A-C, bolts 74 serve to mount housing 60 the central shaft 16, which, again, gyrates from side to side with the rotation of eccentric 22 but should not rotate. As shown in FIG. 11, flat segments 76 in housing 60 receive the flattened edges 58 of end cap 52 (see FIG. 5) to ensure that the housing does not rotate with respect to the adjacent components.

As seen best in FIGS. 1-2B, a shallow oil pan 78 is provided in the bottom of the crusher below the pressure plate apparatus 12. Oil pan 78 will tend to collect lubricating oil as it drains from radial bearing 28 and an eccentric bearing 80 before draining through a drainage port (not shown) and returning to a lubricating oil reservoir (not shown). Oil flowing into pan 78 ensures that the sliding surfaces between the upper surface of pressure plate 38 and the lower surface of thrust washer disc 40 are fully lubricated and sufficiently cooled while shaft 16 gyrates from side to side and the pressure plate and thrust washer disc surfaces are sliding across each other.

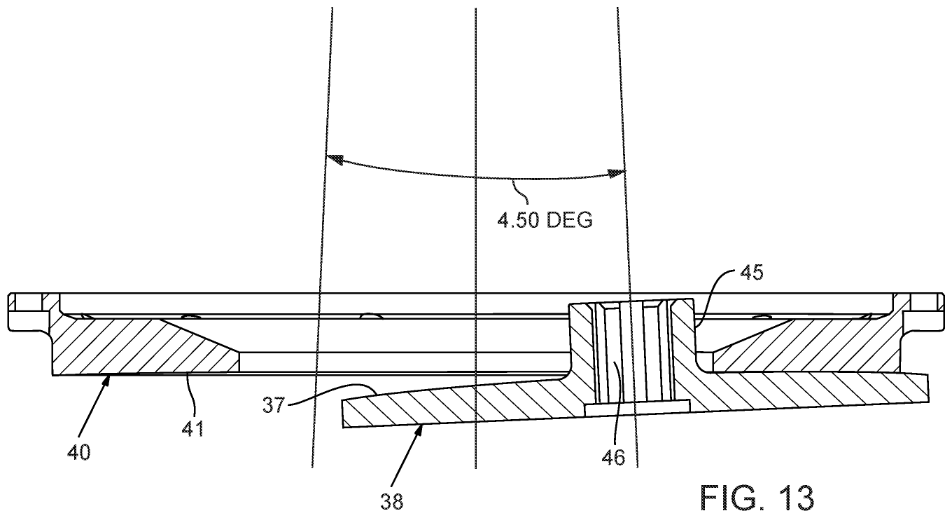

The lubrication between the upwardly-facing surface 37 of pressure plate 38 and the downwardly-facing surface lower surface 41 of thrust washer disc 40 is further facilitated by the fact that the pressure plate may from time to time during crushing operations be moving slightly up and down with respect to the thrust washer disc, as shown by the arrows in FIG. 2B. FIGS. 2B and 13 depict pressure plate 38 in its upper-most position against thrust washer disc 40. Upward and downward axial movement of pressure plate 38 is made possible by springs 62, which provide a pulling force on central shaft 16. This in turn ensures that there is pressure between the previously-discussed cone head ball surface 14 and stationary socket 18, minimizing and normally preventing rotation of cone head 13 and central shaft 16. This relatively constant pressure between ball surface 14 and socket 18 also minimizes and normally prevents any cone head lift, resulting from overly-viscous lubricating oil during start up in cold conditions. The cone head ball surface and the stationary socket may sometimes be referred to herein as a first and a second thrust-bearing surface.

It has been determined that in some instances if the upwardly-facing surface 37 of pressure plate 38 extends at all upwardly or is even perfectly perpendicular to central shaft 16, debris might become lodged and trapped between pressure plate 38 and thrust washer disc 40. To avoid this phenomenon, the upwardly-facing surface 37 of pressure plate 38 may be designed to extend downwardly. It may even take a slightly generally convex configuration with respect to central shaft 16. In other instances (not shown) the entire pressure plate may be downwardly-extending or in some cases downwardly convex. If a radiused curvature is used for the upwardly-facing surface of pressure plate 38, a typical radius would be about 71 inches, although this will depend on the dimensions of the crusher and the pressure plate system.

In many instances where upwardly-facing surface 37 is downwardly-extending or even convex, the downwardly-facing surface 41 of thrust washer disc 40 may also be downwardly-extending or, in some cases, downwardly convex. In many instances, surfaces 37 and 41 will be complementing in their downward extension or if convex, in their convex configuration. In many instances, this complementing degree of downward extension or convex-ness might be precisely the same.

As a result of the downwardly-extending interface between the disc and the pressure plate, any debris that is disposed between thrust washer disc 40 and the pressure plate will tend to move radially outwardly until it drops off the outer periphery of the pressure plate. This phenomenon will tend to reduce or eliminate the possibility of the pressure plate and thrust washer disc overheating due to the presence of such debris.

The degree of downward extension of the upwardly-facing surface 37 of pressure plate 38 and the downwardly-facing surface 41 of thrust washer disc 40 will vary depending up the particular application. However, as shown in FIG. 13, it has been determined that an inclination of about 4.5 degrees is ideal, with a range being something in the neighborhood of 1-10 degrees.

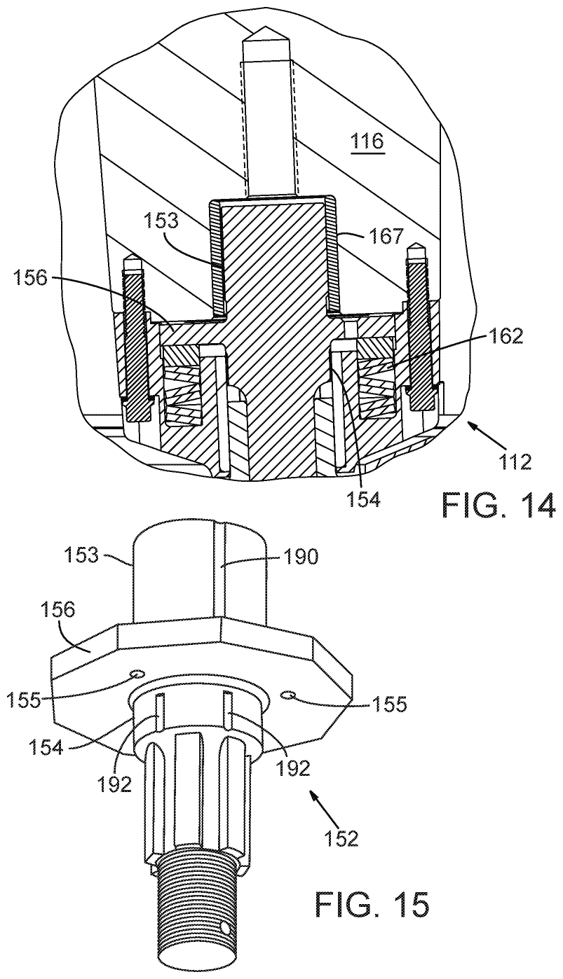

### Embodiment of FIGS. 14 and 15

Because most of the features of the second embodiment depicted in FIGS. 14 and 15 are identical or substantially the same as those of crusher 10 described above, the entire crusher has neither been shown nor identified. Because even the pressure plate system is largely the same as the prior embodiment 12, corresponding numbers in the 100 series will be used for this slightly different pressure plate system 112.

The difference in this second embodiment is that the end cap 152 has an upper portion 153 that extends upwardly into the central shaft 116, which may include a bushing or bearing 167. This means that end cap 152 includes features on both the top and bottom of broad platform 156 that provide increased stability to the end cap as it moves up and down with the action of springs 162. Raised annular shoulder 154 continues to provide stability below platform 156 of the end cap; however, in this embodiment upper portion 153 provides an additional guide surface in central shaft 116 to ensure that end cap 152 does not tilt to one side or the other as it moves up and down.

As shown in FIG. 15, lubrication grooves 190 and 192 extend axially along annular shoulder 154 and upper portion 153, respectively, via lubricating holes 155 and interconnecting lubrication channels (not shown).

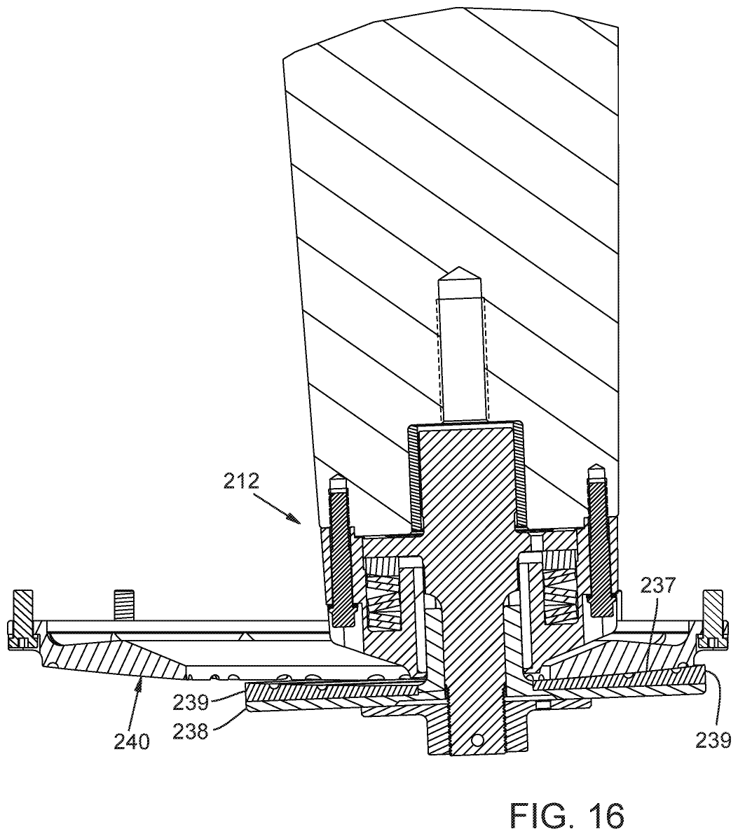

### Embodiment of FIG. 16

FIG. 16 depicts a third embodiment of the pressure plate system. Because most of the features of this variation are identical or substantially the same as the earlier embodiments, the entire crusher has not been show. As with embodiment 110, because even the pressure plate system 212 of this second alternative embodiment is largely the same as the prior embodiment 12, corresponding numbers in the 200 series will be used.

In this third embodiment 212, the curvature and configuration of upwardly-facing surface 237 of pressure plate 238 may be modified by using a flat pressure plate 238 and mounting to it a wear liner 239. The wear liner 239 may take a wide variety of configurations. The depicted wear liner 239 is shown to be upwardly concave, although it might alternatively be flat or upwardly convex. In any event, use of a wear liner 239 facilitates replacement when a change of configuration is desired or if upwardly-facing surface 237 becomes excessively worn. A disc 240 formed of cast iron has been found to be particularly appropriate when a bronze wear liner 239 is utilized.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A system for maintaining a downward force on a central shaft of a cone crusher having a stationary frame, wherein the central shaft is mounted to gyrate with respect to the stationary frame, comprising:
a disc fixed to the frame and having a substantially centrally-disposed opening; and
a pressure plate mounted to and biased toward the central shaft and positioned below the disc, the pressure plate having a surface that faces the disc and extends downwardly, wherein the bias of the pressure plate toward the central shaft biases the pressure plate against the disc during at least some crushing operations, and the disc exerts a downward force on the pressure plate and on the central shaft to which the pressure plate is mounted during the at least some operations.

2. The system of claim 1 wherein the bias is imparted by at least one spring disposed between the pressure plate and the central shaft.

3. The system of claim 2 wherein the at least one spring comprises a stack of Belleville springs.

4. The system of claim 1 wherein the surface of the pressure plate facing the disc is generally convex.

5. The system of claim 1 wherein the disc includes a downwardly-facing surface that extends downwardly, with a configuration complementing that of the pressure plate.

6. The system of claim 4 wherein the disc includes a downwardly-facing surface that is generally convex.

7. The system of claim 6 wherein the shape of the downwardly-facing surface of the disc and the shape of the upwardly-facing surface of the pressure plate complement each other.

8. The system of claim 7 wherein the shape of the downwardly-facing surface of the disc and the shape of the upwardly-facing surface of the pressure plate are the same.

9. The system of claim 2, further comprising a housing mounted to the central shaft and an end cap mounted to the pressure plate, with the at least one spring disposed between the housing and the end cap.

10. The system of claim 9 wherein the housing and the end cap are slidably mounted to each other.

11. The system of claim 9 wherein the end cap and the central shaft are slidably mounted to each other.

12. The system of claim 11 wherein the end cap extends upwardly into the central shaft.

13. The system of claim 1 wherein the pressure plate includes a replaceable wear insert facing the disc that may be replaced when it is desired to change the configuration of the pressure plate or when the wear insert becomes worn.

14. A pressure plate apparatus for mounting to a gyrating central shaft in a cone crusher having a stationary frame, the pressure plate apparatus including a pressure plate that provides a downward force on the central shaft during at least some crushing operations, comprising:
a housing mounted to an underside of the central shaft;
an end cap mounted to the pressure plate and slidably mounted to the housing;
at least one spring positioned between the housing and the end cap to bias the pressure plate toward the central shaft;
a disc fixed to the stationary frame and disposed above the pressure plate, the disc having a substantially centrally-disposed opening;
wherein the pressure plate gyrates with the central shaft, with the disc exerting a downward force on the at least one spring, the pressure plate and the central shaft; and
wherein the pressure plate and the disc extend downwardly in generally convex configurations.

15. The apparatus of claim 14 wherein the disc opening is generally circular and has a first diameter, and the pressure plate has a second diameter that is greater than the first diameter of the disc opening.

16. The apparatus of claim 14 wherein the end cap extends upwardly into the central shaft.

17. A process for maintaining downward pressure on the cone of a cone crusher having a stationary frame, a central shaft, and an eccentric that gyrates the central shaft with respect to the frame, the process comprising the following steps, not necessarily in the order recited:
selecting a pressure plate having a downwardly-extending upwardly-facing surface;
positioning at least one spring between the central shaft and the pressure plate;
fixing a disc to the frame, the disc having a downwardly-extending and downwardly-facing surface and a centrally-disposed opening ;
mounting the pressure plate to the central shaft such that the upwardly-facing surface of the pressure plate faces the downwardly-facing surface of the disc, the at least one spring exerting an upward bias on the pressure plate toward the disc, with the disc exerting a downward force on the pressure plate and the central shaft during at least a portion of the time the crusher is performing crushing operations.

18. A process for maintaining downward pressure on the cone of a cone crusher having a stationary frame, a central shaft, a first and a second thrust bearing surface mounted to the central shaft that absorb at least some downward thrust during crushing operations, and a rotating eccentric that gyrates the central shaft with respect to the frame, the process comprising the following steps, not necessarily in the order recited:
mounting a housing to the central shaft;
positioning at least one spring adjacent the housing;
slidably mounting an end cap to the housing such that the at least one spring is disposed between the housing and the end cap;
fixing a disc to the frame, the disc having a substantially centrally-disposed opening, and a generally convex downwardly-facing surface;
selecting a plate having a generally convex upwardly-facing surface; and
mounting the plate to the end cap such that the disc is disposed between the plate and central shaft and the at least one spring biases the plate toward the disc so that the disc and the plate exert a downward force on the central shaft, and the plate gyrates with the central shaft and with respect to the disc.

19. The process of claim 18, further comprising causing any debris disposed between the pressure plate and the disc to move radially outwardly until it drops off the pressure plate.

20. The process of claim 18, wherein the step of selecting a plate comprises selecting a place with an upwardly-facing surface that is in the form of a removable wear insert.

21. The process of claim 20, further comprising replacing the wear insert.

22. A system for maintaining a downward force on a central shaft of a cone crusher having a stationary frame, comprising:
a disc fixed to the frame, the disc having a substantially centrally-disposed opening; and
a plate mounted to the central shaft, with at least one spring disposed to exert an upward bias on the plate with respect to the central shaft, wherein the plate and the disc are positioned against each other during at least some of the operations of the crusher so that the disc presses downwardly on the plate to exert a downward bias on the central shaft, wherein the plate includes a replaceable wear insert facing the disc that may be replaced when it is desired to change the configuration of the plate or when the wear insert becomes worn.

23. The system of claim 22, further comprising a housing fixed to the central shaft, with the at least one spring disposed within the housing.

24. The system of claim 23, further comprising an end cap fixed to the plate and slidably mounted to the housing, with the at least one spring disposed to exert a bias between the housing and the end cap.

25. The system of claim 22 wherein gyration is imparted to the central shaft by an eccentric, and the gyration of the central shaft is passed to the plate, which gyrates with respect to the disc.
